(19) United States
(12) Patent Application Publication
(10) Pub. No.: US 2009/0084370 A1
(43) Pub. Date: Apr. 2, 2009

(54) Apparatus for Calculating Combustion Energy of Internal Combustion Engine

(75) Inventors: Toshihiro Aono, Abiko (JP); Satoru Watanabe, Maebashi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/193,318

(22) Filed: Aug. 18, 2008

(30) Foreign Application Priority Data
Sep. 28, 2007 (JP) 2007-252956

(51) Int. Cl. F02D 41/00

(52) U.S. Cl. 123/704

(57) ABSTRACT

An apparatus for calculating combustion energy of an internal combustion engine having a rotational velocity calculation unit for calculating a rotational velocity of a crank from a time required for the crank angle to change by a predetermined angle, a rotational acceleration calculation unit for calculating a rotational acceleration from the rotational velocity, a filter for extracting components synchronous with engine combustion from a signal representative of rotational velocities, and a gate for delivering a filter output when the rotational acceleration takes a minimum value, wherein the length of the filter equals one engine cycle/the number of cylinders.

### BACKGROUND OF THE INVENTION

The present invention relates to an apparatus for estimating combustion energy of each cylinder on the basis of the rotation of a crankshaft of an internal combustion engine.

In a method of estimating a fluctuation in torque of an internal combustion engine, a rotational angular velocity of an engine crankshaft is detected and a torque fluctuation is estimated from a change in the angular velocity. In connection with this type of estimation method, a torque fluctuation estimating method has hitherto been proposed, according to which it is decided whether the engine running condition assumes such a first running state that the torque fluctuation is exhibited with higher reproducibility and higher remarkableness by a waveform indicative of a change in combustion primary angular velocity than by a waveform indicative of a change in angular velocity attributable to an intrinsic vibration of the crankshaft or such a second running state that the torque fluctuation is exhibited with higher reproducibility and higher remarkableness by the latter waveform than by the former waveform and when the first running state is determined, the torque fluctuation is estimated from a difference between the minimum value of angular velocity at the beginning of the combustion stroke and the maximum value of angular velocity in the course of combustion stroke.

In the conventional technique disclosed in JP-A-2007-32433, the torque fluctuation is estimated from the change of angular velocity in the curse of combustion stroke but in order to accurately calculate amounts of energy per combustion the engine consumes to rotate the crankshaft, work the pressure prevalent in the cylinder exerts upon the piston during the combustion stroke and work the pressure prevalent in the cylinder receives during the compression stroke must both be calculated to reckon net work.

### SUMMARY OF THE INVENTION

An object of the present invention is to estimate combustion energy of an internal combustion engine accurately.

According to the present invention, combustion energy can be calculated accurately every combustion event by an apparatus for calculating combustion energy of an internal combustion engine comprising rotational velocity (angular velocity) calculation means for calculating a rotational velocity (angular velocity) of a crank from a time required for the crank angle to change by a predetermined angle, rotational acceleration (angular acceleration) calculation means for calculating a rotational acceleration (angular acceleration) from the rotational velocity, a filter for extracting components synchronous with combustion of the engine from a signal representative of rotational velocities, and gate means for delivering a filter output when the rotational acceleration takes a minimum value, the length of the filter being equal to one engine cycle/the number of cylinders.

Then, by making coefficients of the filter comply with an odd function relative to the center of the filter, a value representative of the difference of subtraction of the work the pressure prevalent in the cylinder receives during the compression stroke from the work the pressure prevalent in the cylinder exerts during the combustion stroke can be calculated to reckon net combustion energy.

For surveying the combustion energy during each combustion of the internal combustion engine, a method by which an intra-cylinder pressure sensor is mounted to each cylinder to calculate an intra-cylinder pressure is the most trustworthy but with the method of the present invention used, combustion energy during each combustion event can advantageously be calculated by means of only a crank angle sensor and the combustion energy can be calculated at low costs to advantage.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the construction of an internal combustion engine used in embodiments of the present invention.

FIG. 2 graphically illustrates how the intra-cylinder pressure, rotational acceleration of the crankshaft and rotational velocity thereof are related to the crankshaft angle.

FIG. 3 is a graph showing the relation between volume and pressure in the internal combustion engine.

FIG. 4 is a diagram showing an embodiment of the invention.

FIG. 5 is a schematic diagram for explaining a crank angle sensor in the embodiment of the invention.

FIG. 6 is a graphical representation showing pulses delivered out of the crank angle sensor.

FIGS. 7A to 7D are graphical representations showing examples of coefficients of a filter.

FIG. 8 is a graphical representation showing still another example of filter coefficients.

FIG. 9 is a diagram showing another embodiment of the invention.

FIG. 10 is a diagram showing still another embodiment of the invention.

FIG. 11 is a schematic block diagram illustrating an embodiment of cylinder unevenness calculation unit to which the present invention is applied.

FIG. 12 is a flowchart for the FIG. 4 embodiment of the invention.

### DESCRIPTION OF THE EMBODIMENTS

Embodiments of the present invention will now be described with reference to the accompanying drawings.

### Embodiment 1

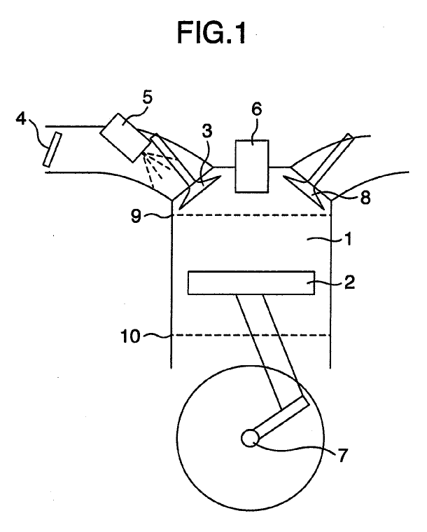

Typically, an internal combustion engine includes a plurality of cylinders, of which one is noticed particularly and extracted as shown in FIG. 1. In the internal combustion engine, while a piston 2 makes two events of reciprocation, four cycles of intake, compression, combustion and exhaust are executed. As an inlet valve 3 opens in synchronism with a down stroke of the piston 2 from a top dead center 9 to a bottom dead center 10, a mixture of air throttled by a throttle 4 and fuel injected from an injector 5 flows into a cylinder 1. As the piston 2 reaches the bottom dead center, the inlet valve 3 closes and the piston 2 goes up. The air enclosed in the cylinder 1 is compressed by means of the piston 2. As the piston 2 reaches the top dead center, the mixture in the cylinder 1 is fired by means of an ignition plug 6 and an combustion event starts. Energy generated by the combustion pushes down the piston 2 and a pressure thus applied to the piston 2 is transmitted, generating torque for rotating the crankshaft 7.

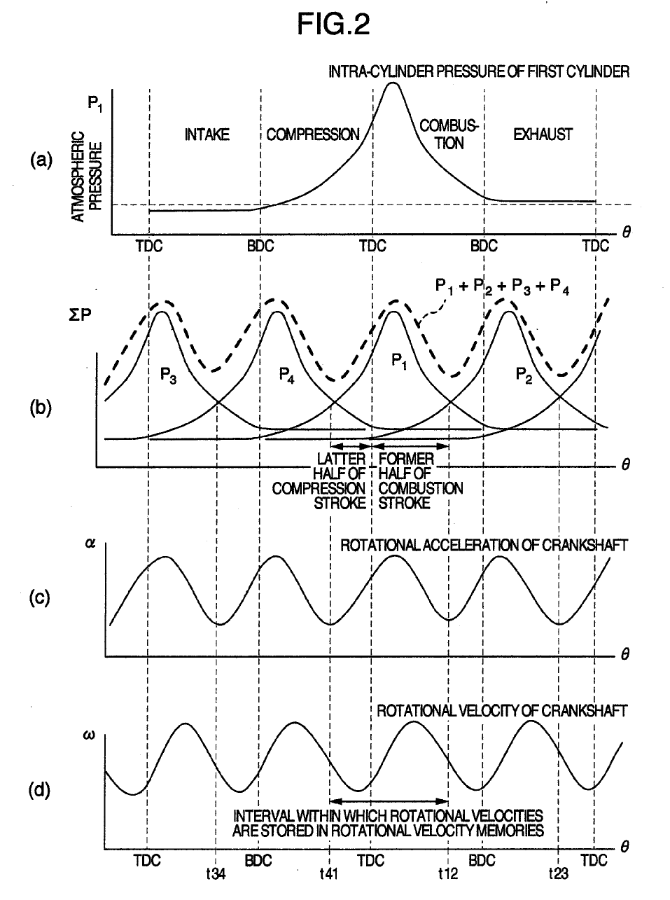

The relation between intra-cylinder pressure Pi and crank angle θ of crank shaft 7 is graphically illustrated at section (a) in FIG. 2. Particularly illustrated at section (a) in FIG. 2 is an intra-cylinder pressure in a first cylinder. In the intake stroke, the intra-cylinder pressure is substantially equal to or slightly lower than inlet pipe pressure. In the compression stroke, the pressure grows as the piston approaches the top dead center. In the combustion stroke, the pressure further grows as firing occurs near the top dead center and this intra-cylinder pressure pushes down the piston, with the result that the volume expands and the pressure gradually decreases to approach the atmospheric pressure. As the piston reaches the bottom dead center, the exhaust stroke starts to open the exhaust valve, enabling exhaust gas in the cylinder 1 to be exhausted. At that moment, the intra-cylinder pressure is substantially equal to or slightly higher than the atmospheric pressure.

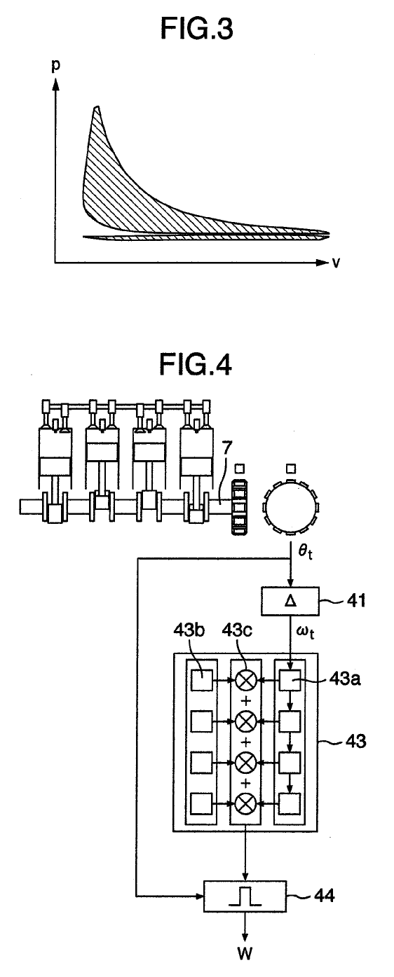

In the four cycles as above, the volume is related to the pressure in the combustion chamber as graphically illustrated in FIG. 3 and the combustion energy is defined by an area hatched in the figure.

The force by which the intra-cylinder pressure thrusts the piston is converted through a link mechanism into torque T for rotating the crankshaft. Typically, the internal combustion engine has plural cylinders and the torque for rotating the crankshaft is substantially proportional to the sum of pressures in all of the cylinders as indicated by dotted curve at section (b) in FIG. 2. Then, the rotational acceleration of crankshaft is proportional to the torque, thus developing as illustrated at section (c) in FIG. 2. The rotational velocity ω of crankshaft is obtained by integrating the rotational acceleration and is therefore shifted in phase by ¼ wavelength as illustrated at section (d) in FIG. 2.

For example, in the case of the 4-cylinder engine, an combustion event takes place in the four cylinders and the magnitude of the combustion can be evaluated by an intra-cylinder pressure. Therefore, for determining amounts of combustion energy of individual combustion events, four pressure sensors are necessary in principle. But the amounts of combustion energy in the four individual cylinders are herein managed to be determined from a single physical quantity represented by the rotational velocity of crankshaft. This expedient is possible because the rotational velocity of crankshaft is partitioned by the crank angle.

Making reference to section (b) in FIG. 2 illustrating the superposition of intra-cylinder pressures of the four cylinders in the four-cylinder engine, it will be understood that the pressure in each cylinder substantially equals the sum of pressures in all of the cylinders over the latter half of compression stroke and the former half of combustion stroke which have close intimacy with the combustion energy. Accordingly, by performing partition to provide an interval at such times t34, t41 . . . when the maximum-pressure-cylinder changes (rotational velocity signal for one engine cycle is divided into partitioned intervals by the number of cylinders) and making the thus partitioned interval correspond with the cylinder having the highest pressure at that moment, sensor information for calculating the combustion energy of each combustion event can be obtained. Actually, since the cost for measuring the intra-cylinder pressure of every cylinder is expensive, a method is employed in which crank angles providing times t34, t41 . . . are stored in advance in a memory or the partition is executed at a middle point between a time at which ω is maximized and a time at which ω is minimized.

In the apparatus of the present embodiment, combustion energy of each of the events of combustion in the internal combustion engine is determined on the basis of the idea as above.

Referring to FIG. 4, an apparatus according to an embodiment of the present invention is constructed as illustrated therein.

The apparatus comprises a rotational velocity calculation unit 41 for calculating a rotational velocity ω of crankshaft 7 from a time required for crank angle θ to change by a predetermined angle Δθ, a filter 43 for extracting components synchronous with combustion of the engine from a signal representative of the rotational velocities ω and a gate unit 44 for delivering a filter output at a predetermined crank angle θcomb in the combustion stroke of a cylinder targeted for combustion energy calculation, and the length of the filter 43 is defined by (θcomb−θcomp)/Δθ, where θcomp represents a predetermined crank angle in the compression stroke and the θcomp and θcomb define start and end points of an interval targeted for combustion energy calculation.

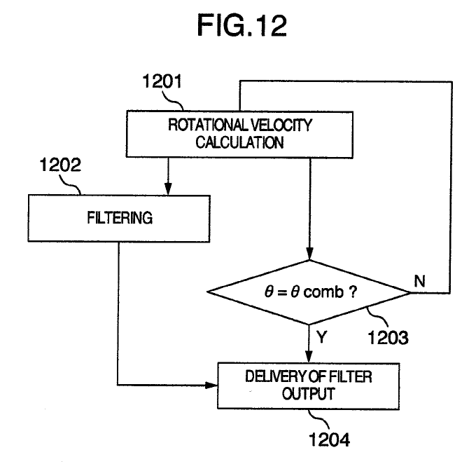

Operation of the present embodiment will now be described by referring to a flowchart of FIG. 12.

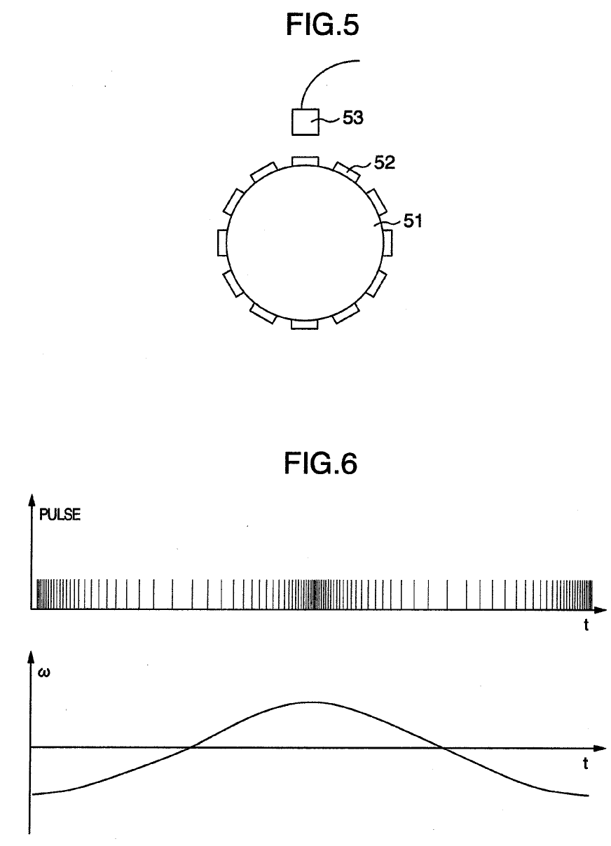

Incidentally, a disk 51 made of metal as shown in FIG. 5 is mounted to the crankshaft of the internal combustion engine and teeth 52 also made of metal are attached to the outer circumference of the disk at equal intervals. Rotation of the crankshaft is measured by means of a magnetic sensor 53. The rotational velocity of crankshaft 7 is calculated from an analog signal which depends on the distance between disk 51 and magnetic sensor 53. When the analog signal exceeds, during its rising, a threshold value set in advance, pulses as shown in FIG. 6 are generated. The pulse interval is short for ω being fast but is long for ω being slow and the rotational velocity of crankshaft 7 is expressed by condensation and rarefaction of the pulse interval.

Each time that the rotational velocity calculation unit 41 receives the individual pulses, it measures a time interval Δt between the present pulse and the preceding pulse and divides inter-teeth distance Δθ by Δt to calculate rotational velocity ω=Δθ/66 t (step 1201).

The filter 43 includes rotational velocity memories being N=(θcomb−θcomp)/Δθ in number, the same number of filter coefficient memories 43b and the same number of multipliers 43c. The rotational velocity memories store rotational velocities developing at instants covering the present instant and an instant retroacting by N pulses from the present instant. As the rotational velocity calculation unit has computed a rotational velocity, the rotational velocities already stored till then in the memories are shifted one by one in accordance with arrow 43a and then a newly calculated rotational velocity is stored in the uppermost-unoccupied memory. Thereafter, each time that a new rotational velocity is calculated, the multiplier computes a product of the rotation velocity and the filter coefficients so that products may be totalized to enable the sum to be delivered to the gate unit 44. The rotational velocities stored in the memories correspond to those in the latter half of compression stroke and the former half of combustion stroke which belong to a cylinder. Values of θcomb and θcomp are so set in advance that filtering results of rotational velocities ω in the interval [θcomp, θcomb] are correlated at the highest to values of combustion energy calculated from the pressure sensor.

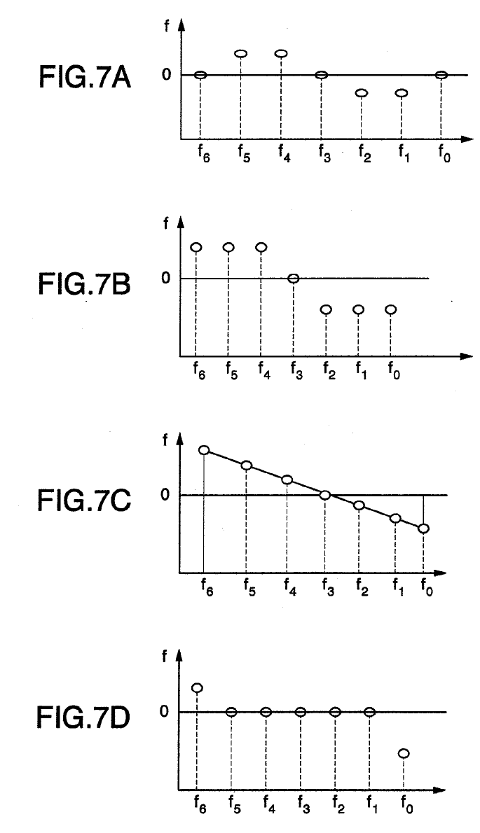

Filter coefficients f_0, f_1, . . . , f_(N−1) stored in the filter coefficient memories 43b are set point-symmetrically to the center point, complying with an odd function as shown in FIGS. 7A to 7D.

The reasons why the filter complies with an odd function are as follows:

(1) When a DC component is inputted to the odd function filter, its output is 0 because the average of coefficients of odd function is 0.

(2) Net work the intra-cylinder pressure exerts on the piston can be determined by canceling work the piston exerts on the intra-cylinder pressure during the compression stroke from work the intra-cylinder pressure exerts on the piston during the combustion stroke. This is because signs of coefficients concerning the compression range are inverse to those of coefficients concerning the combustion range.

Conceivably, the filter coefficients may comply with a trigonometric function as shown in FIG. 7A. With the filter of trigonometric function, the sensitivity of the filter is maximized at a length obtained by dividing one cycle of the internal combustion engine by the number of cylinders. Alternatively, values of the same absolute values having inversed signs in the left and right sides of the center, respectively, may be taken as shown in FIG. 7B or the coefficient may decrease linearly having its center value of zero as shown in FIG. 7C. Further, coefficients at the opposite ends may be of the same absolute value having inverted signs and the other coefficients may all be 0 as shown in FIG. 7D.

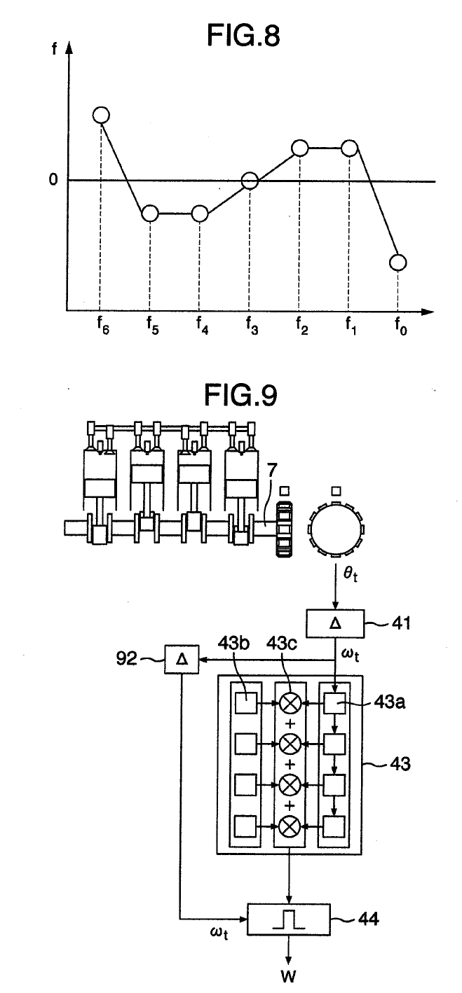

In addition, in the case of a filter complying with an odd function and exhibiting a moment of 0 (zero) as shown in FIG. 8, the influence the acceleration and deceleration developing at a constant ratio have can be cancelled (step 1202).

As the crank angle reaches the θcomb at which the interval for calculation of combustion energy ends, the rotational velocities stored in the rotational velocity memories inside the filter 43 complete the interval [θcomp, θcomb] for calculation of the combustion interval. Accordingly, when the crank angle coincides with θcomb (step 1203), the gate is opened to permit a filter output to be delivered (step 1204).

By adjusting the coefficients of the filter skillfully, the delivered value can be allowed to express combustion energy of each combustion in the internal combustion engine.

With the apparatus for calculating combustion energy of an internal combustion engine as constructed above, work the intra-cylinder pressure receives during the compression stroke can be cancelled from work the intra-cylinder pressure exerts during the combustion stroke and net work the intra-cylinder pressure exerts on the crankshaft can be calculated.

### Embodiment 2

While in embodiment 1 rotational velocities ω developing between a point in the compression stroke and a point in the combustion stroke are filtered in a bid to determine the combustion energy, the interval of filtering is determined by taking notice of rotational acceleration α in the present embodiment.

In the compression and combustion strokes, rotational velocities and rotational accelerations of the crankshaft develop as shown at sections (d) and (c) in FIG. 2. The interval starting at a point in the compression stroke and ending at a point in the combustion stroke as explained in connection with embodiment 1 includes a point at which the compression stroke changes to the combustion stroke, that is, a point at which the angular acceleration is maximized. Then, when an interval ranging from a point at which the rotational acceleration is minimized to a point at which the next minimum develops is considered as corresponding to one combustion, all crank angles can be covered without doubling and omission. Where this interval is concerned, the rotational acceleration increases from a minimum point to a maximum point and thereafter it decreases until the next minimum point. Accordingly, the interval targeted for calculation of combustion energy is considered to include a point at which the rotational acceleration becomes maximum, a range preceding the point within which the rotational acceleration increases and a range succeeding the point within which the rotational acceleration decreases. Structurally, the present embodiment for calculating the combustion energy from the interval as above can be identical to embodiment 1 with the only exception that the timing of opening the gate and the length of the filter differ from those in embodiment 1. By using a predetermined point θinc in the range adapted for increasing the rotational acceleration and precedently adjoining the point at which the rotational acceleration is maximized and a predetermined point θdec in the range adapted for decreasing the rotational acceleration and successively adjoining the point at which the rotational acceleration is maximized, the gate is opened at a timing that the crank angle reaches θdec and the length of filter is given by N=(θdec−θinc)/Δθ.

With the apparatus for calculating combustion energy of an internal combustion engine as constructed above, work the intra-cylinder pressure receives during the compression stroke can be cancelled from work the intra-cylinder pressure exerts during the combustion stroke and net work the intra-cylinder pressure exerts upon the crankshaft can be calculated.

### Embodiment 3

While in embodiment 2 the increase/decrease in rotational acceleration α comes up to determine the filtering interval, rotational velocities developing in an interval between a minimum value of rotational acceleration and the next minimum value thereof are filtered to determine combustion energy in the present embodiment.

Structurally, the present embodiment constructed as above is identical to embodiments 1 and 2 with the only exception that the timing of opening the gate differs and the filter length differs. The gate is opened at a timing of a point θmin where the rotational acceleration of the crankshaft is minimized and the filter length equals a division of one cycle by the number of cylinders.

With the apparatus for calculating combustion energy of an internal combustion engine as constructed above, work the intra-cylinder pressure receives during the compression stroke can be cancelled from work the intra-cylinder pressure exerts upon the piston during the combustion stroke and net work can be calculated.

### Embodiment 4

While in embodiment 3 the crank angle θmin where the rotational acceleration of the crankshaft is minimized has been studied in advance to enable the gate to be opened when this angle is reached but without resort to the preparatory examination, an angular acceleration α may be calculated from an angular velocity ω and when α becomes minimal, the gate may be opened. The present embodiment to this effect is constructed as shown in FIG. 9. Structurally, in the present embodiment, a rotational acceleration calculation unit 92 is added to the construction of embodiment 1 shown in FIG. 4. In the present embodiment, the rotational velocities of crankshaft calculated by the rotational velocity calculation unit 41 are filtered through the filter 43 whereas rotational accelerations a of crankshaft are calculated in the rotational acceleration calculation unit 92. As the rotational acceleration a becomes minimal, the gate unit 44 delivers results of the filter 43. The length of the filter is the same as that in embodiment 3, amounting to a division of one cycle by the number of cylinders.

With the apparatus for calculating combustion energy of an internal combustion engine as constructed above, work the intra-cylinder pressure receives during the compression stroke can be cancelled from work the intra-cylinder pressure exerts during the combustion stroke and net work can be calculated.

### Embodiment 5

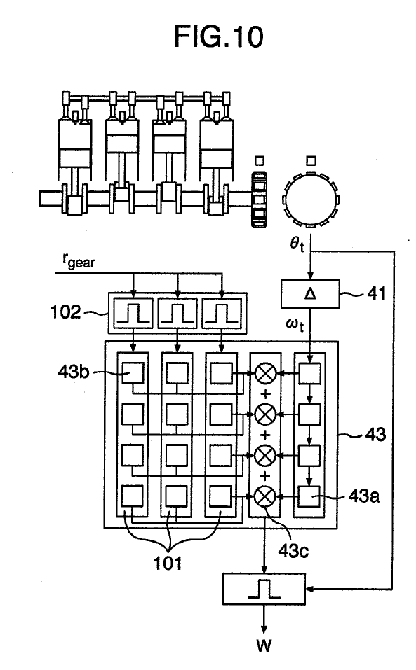

FIG. 2 referred to in connection with embodiment 1 implies that the rotational acceleration of crankshaft is proportional to torque. It is likely that the proportional coefficient in this case will change with the inertia of the engine. In the case of automatic transmission, a wheel side enclosing the engine and a torque converter is separated by a fluid machine called torque converter and therefore the inertial of a portion ahead of the torque converter can be negligible but in the case of manual transmission, a portion ending in the wheels is connected in the form of a single rigid body. Consequently, the inertial as viewed from the engine will changes with the gear ratio of the transmission mechanism. Therefore, the filter coefficients need to be changed according to the gear ratio of transmission. Construction aiming at this point is illustrated in FIG. 10. Structurally, a plural sets of filter coefficients 101 are provided in the filter 43 in correspondence with gear ratios, one of the sets is selected by a selection unit 102 according to a gear ratio and a filter corresponding to the gear ratio is incorporated in the rotational velocity of crankshaft, so that a gear ratio dependent difference in inertia as viewed from the engine can be corrected to calculate correct combustion energy.

### Embodiment 6

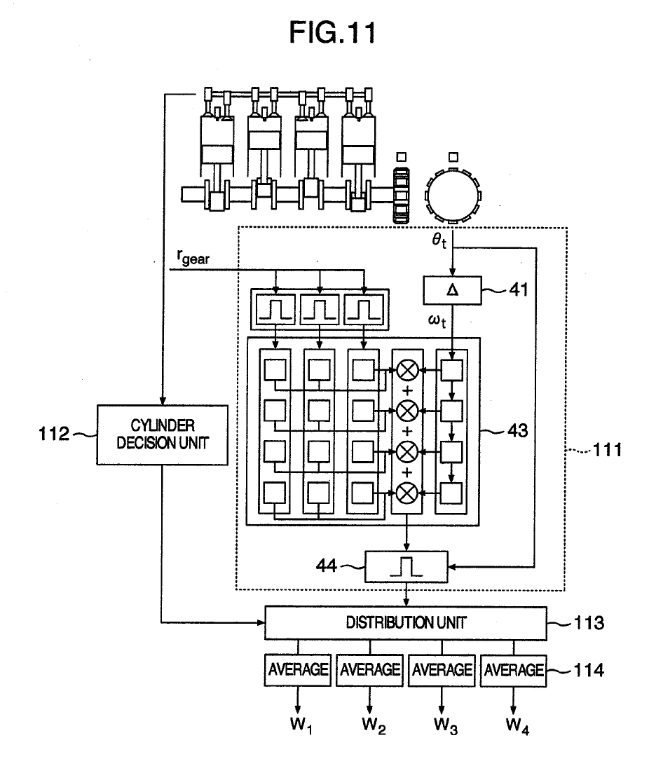

The amount of intake air to individual cylinders will sometimes be uneven under the influence of such a factor as a production error of the cam for driving the intake valve. Preferably, by detecting such an unevenness and controlling the combustion cylinder by cylinder, the unevenness in intake amount is corrected to smoothen combustion energy in the engine. To this end, the present embodiment is directed to calculate the dispersion in combustion energy. The present embodiment is constructed as shown in FIG. 11. The present embodiment comprises, in addition to a combustion energy calculation unit 111 as described previously in connection with embodiments 1 to 5, a cylinder decision unit 112, a distribution unit 113 and an average unit 114 provided for each cylinder.

In the cylinder decision unit 112, a cylinder on the excursion of from compression stroke to combustion stroke is identified from an angle of the camshaft. In the distribution unit 113, combustion energy of each combustion calculated by the combustion energy calculation unit 111 is distributed to the cylinder on the excursion of combustion stroke. Amounts of combustion energy distributed to individual cylinders are smoothened by the average unit 114 and a cylinder-dependent combustion energy dispersion is calculated.

It should be further understood by those skilled in the art that although the foregoing description has been made on embodiments of the invention, the invention is not limited thereto and various changes and modifications may be made without departing from the spirit of the invention and the scope of the appended claims.

1. An apparatus for calculating combustion energy of an internal combustion engine, comprising:
rotational velocity calculation means for calculating a rotational velocity of a crank from a time required for the crank angle to change by a predetermined angle; and
a filter for extracting components synchronous with engine combustion from a signal representative of rotational velocities over a predetermined interval,
wherein said predetermined interval starts in a compression stroke of a cylinder whose combustion energy is calculated and ends in an combustion stroke of the same cylinder.

2. An apparatus for calculating combustion energy of an internal combustion engine according to claim 1,
wherein said predetermined interval starts and ends when the pressure of a compression-stroke-cylinder exceeds the pressure of a combustion-stroke-cylinder.

3. An apparatus for calculating combustion energy of an internal combustion engine according to claim 1,
wherein said predetermined interval starts and ends at a middle point between a time when the rotational velocity is maximum and a time when the rotational velocity is minimum.

4. A filter of the apparatus for calculating combustion energy of an internal combustion engine as recited in claim 1,
wherein coefficients of said filter comply with an odd function which is symmetrical to the center.

5. A filter of the apparatus for calculating combustion energy of an internal combustion engine as recited in claim 1,
wherein said filter has its sensitivity which is maximized at its length represented by a time or an angle equal to division of one cycle of the internal combustion engine by the number of cylinders and complies with an odd function.

6. A filter of the apparatus for calculating combustion energy of an internal combustion engine as recited in claim 1,
wherein coefficients of said filter are calculated in accordance with characteristics of a transmission intervening between the engine and wheels.

7. An apparatus for calculating combustion energy of an internal combustion engine according to claim 1, wherein amounts of combustion energy calculated combustion by combustion are smoothened over individual cylinders to calculate dispersions of combustion energy amounts in individual cylinders of the internal combustion engine.
